(19) United States
(12) Patent Application Publication
(10) Pub. No.: US 2025/0289031 A1
(43) Pub. Date: Sep. 18, 2025

(54) SYSTEM AND METHOD FOR SELF-RETAINING HUNG FLEXIBLE MATERIAL

(71) Applicant: Terex USA, LLC, Norwalk, CT (US)

(72) Inventors: David Odom, Flint, MI (US); David Bryan STROUP, Burt, MI (US); Ryan Anthony MUMM, Newhall, IA (US)

(21) Appl. No.: 19/227,096

(22) Filed: Jun. 3, 2025

Related U.S. Application Data
(63) Continuation of application No. 18/442,602, filed on Feb. 15, 2024, now Pat. No. 12,343,762.
(60) Provisional application No. 63/445,736, filed on Feb. 15, 2023.

(51) Int. Cl. B07B 1/46

(52) U.S. Cl. CPC B07B 1/4609

(57) ABSTRACT

A method and apparatus for allowing access to a screen deck on a vibrating screen which involves bending a flexible barrier sheet upwardly and coupling an upper mounting tab through a flexible sheet mounting tab receiving orifice in said flexible barrier sheet.

### CROSS REFERENCE TO RELATED APPLICATIONS

The present application is a continuation application of non-provisional patent application having Ser. No. 18/442,602 filed on Feb. 15, 2024, which application claims the benefit of the filing date of provisional patent application having Ser. No. 63/445,736 filed on Feb. 15, 2023 by the same inventors, which application is incorporated herein in its entirety by this reference.

### FIELD OF THE INVENTION

The present invention generally relates to material processing, and more particularly relates to vibrating screening machines, and, even more particularly, relates to support structure above hung rubber on vibrating screening machines.

### BACKGROUND OF THE INVENTION

Heavy equipment in the aggregate industry often needs frequent maintenance due to the wear and tear of processing rock and other minerals. Mechanical screens are typically designed with heavy rubber sheets in the back that serve the dual purpose of retaining material during operation of the screen and allowing maintenance workers an access point that does not need to be unbolted or otherwise removed. Note that access from the front is often impeded by chutes. This rubber is often difficult for maintenance workers to hold up while simultaneously moving past and also has the potential to restrict airflow. Moreover, these hung rubber sheets can hide workers that are inside the machine from those working outside, which increases the potential for accidental operation of the machine while maintenance workers are inside of the machine. Consequently, there is need for a way to ensure an effective barrier, with adequate ability for airflow and a clear line of sight for maintenance personnel.

In the past, workers may have propped open the areas covered by the rubber sheets using pole, rods etc., which are prone to be displaced and thereby slipping and temporarily being useless.

While these types of methods to holding open heavy rubber sheets may have many advantages in particular applications, they also have some drawbacks. For example, with the use of poles some challenges are presented. Firstly, frequently adjusting poles that may have slipped can be time consuming and costly. Secondly, more activity inside the machine causes more occurrence for possibility of injury.

Consequently, there exists a need for improved methods and apparatuses for efficiently supporting heavy rubber sheets in vibrating screen machines.

### SUMMARY OF THE INVENTION

It is an object of the present invention to provide an easily implemented system for supporting a heavy rubber sheet in a vibrating screen.

It is a feature of the present invention to utilize a tailgate portion which spans across the screen deck from side to side which has associated therewith tabs or protuberances which are configured to mate with orifices in rubber sheets.

It is an advantage of the present invention to provide for some of the benefits of an ability to hold open heavy sheets without the need for workers to carry tools or implements just for the purpose of holding open the heavy rubber sheets.

It is another object of the present invention to provide an easily implemented method of maintaining an interior portion of a vibrating screen with reduced effort associated with keeping the heavy rubber sheets positioned to allow for airflow and visual inspection.

It is another feature of the present invention to eliminate the need for use of tools to hold open heavy rubber sheets.

It is an advantage of the present invention to provide for a method of making a vibrating screen which incorporates therein equipment for facilitating maintenance thereof without use of tools to hold open heavy rubber sheets.

The present invention is an apparatus and method for efficiently and cost effectively providing support from above for a plurality of heavy rubber sheets, which apparatus and method are designed to satisfy the aforementioned needs, provide the previously stated objects, include the above-listed features, and achieve the already articulated advantages. The present invention is carried out in a “prop pole less system,” in a sense that simple changes to the manufacture of the tailgate and the heavy rubber sheets are used, in combination to provide for holding open the areas normally covered by the heavy rubber sheets without the use of poles, tools or other implements by the maintenance workers.

Accordingly, the present invention is a vibrating screen system, comprising the steps of:
a vibrating screen having at least one screen deck;
at least one flexible barrier sheet having a top portion and a bottom portion;
said top portion being secured to said vibrating screen above said screen deck;
said bottom portion having at least one mounting receiving orifice;
at least one mounting tab disposed on said vibrating screen above said top portion; and
wherein said at least one mounting tab is configured to pass through said at least one mounting receiving orifice to hold said bottom portion in an elevated position creating a maintenance access opening.

Additionally, the present invention is a method of maintaining a vibrating screen comprising:
providing a vibrating screen having at least one flexible barrier sheet secured at an upper portion to said vibrating screen above a screen deck;
bending said flexible barrier sheet upwardly from a hanging position to an elevated position;
securing said flexible barrier sheet in said elevated position by engaging at least one retention element on said vibrating screen with at least one receiving opening in a lower portion of said flexible barrier sheet; and
wherein said securing step creates a maintenance access opening allowing worker access to said screen deck.

### BRIEF DESCRIPTION OF THE DRAWINGS

The invention may be more fully understood by reading the following description of the preferred embodiments of the invention, in conjunction with the appended drawings wherein:

FIG. 1 is a perspective view of a vibrating screening deck of the present invention, which utilizes three rubber sheets 110, 114 and 116 shown in a downward orientation similar to that which might be used during normal operation of the screening machine and a slightly opened configuration of sheet 112.

FIG. 2 is a detailed diagram of a flat screen deck of the present invention with all sheets in a fully downward orientation.

FIG. 3 is a view of the vibrating screen deck of FIG. 1 where the hung rubber on the left is fully flipped up while the hung rubber on the right side is allowed to fully hang down.

FIG. 4 is a detailed view of a flat pattern of the tailgate portion of the present invention before being formed.

FIG. 5 is a view of an alternate embodiment of the present invention for a flat screen deck using the same tapered cross-members as shown in FIGS. 3 and 4.

FIG. 6 is a view of the tailgate portion of FIG. 5 after having been formed.

FIG. 7 is an end view of the tailgate portion of FIG. 6.

FIG. 8 is a perspective view of the tailgate portion of FIGS. 6 and 7.

FIG. 9 is a view of an upper transverse portion generally designated 1300 in a flat orientation before being formed.

FIG. 10 is a side view of the upper transverse portion 1300 after having been formed.

FIG. 11 is an end view of the upper transverse portion 1300 of FIG. 10.

FIG. 12 is a perspective view of the upper transverse portion 1300 of FIGS. 10 and 11.

### DETAILED DESCRIPTION

Although described with particular reference to inclined multi-level vibrating screens, the systems and methods of the present invention for supporting a flexible sheet can be implemented in many different types of vibrating screen applications.

In one embodiment, the system and method of the present invention described herein can be viewed as examples of many potential variations of the present invention which are protected hereunder.

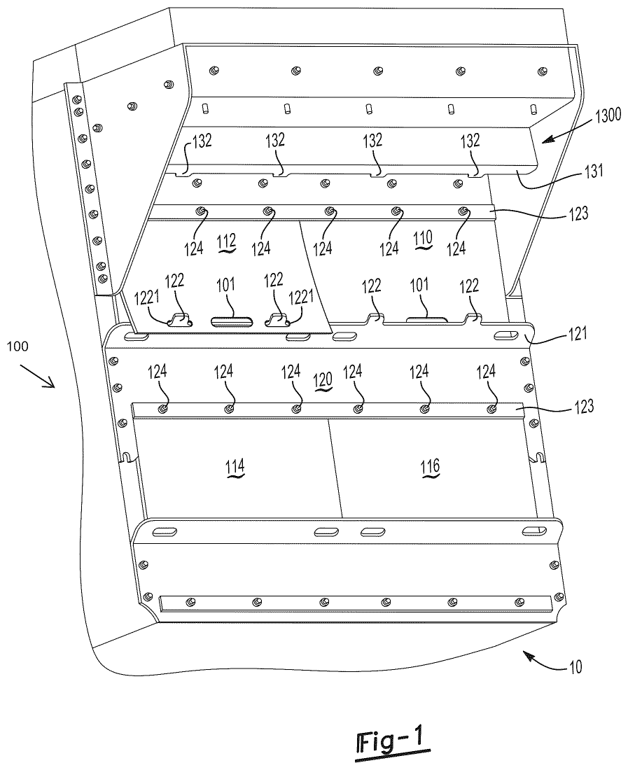

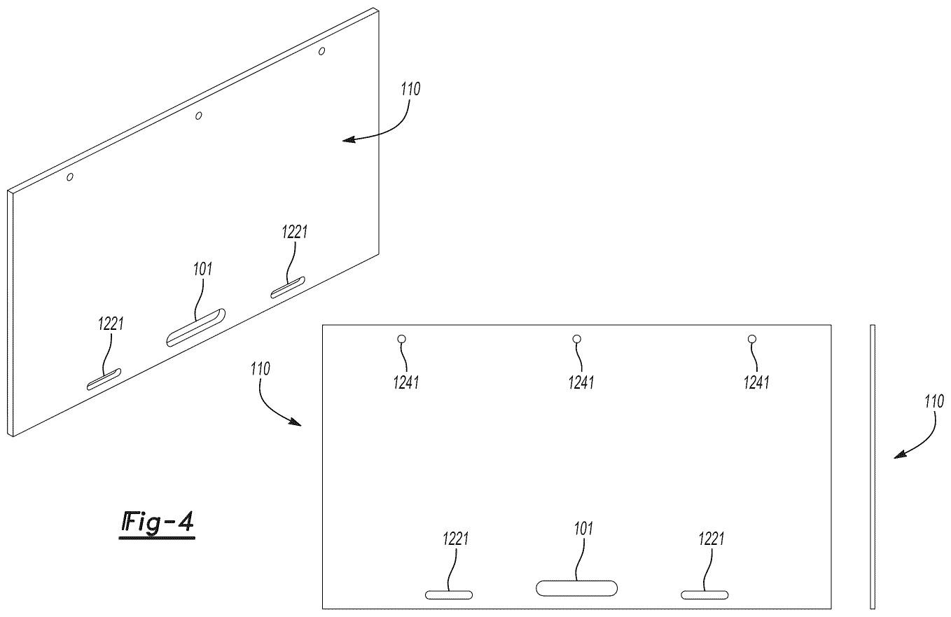

Now referring to the drawings, wherein like numerals refer to like matter throughout, and more particularly FIG. 1, there is shown a diagram illustrating a version of a rectangular multideck screen deck of the present invention. Where two decks of the multi-deck screen have one end thereof selectively covered by flexible barrier sheets 110, 112, 114 and 116. Throughout this description, these are referred to as heavy rubber sheets but it should be understood that any suitable material could be substituted which provides the necessary properties of flexibility, durability, density etc. Flexible barrier sheet 112 is shown in a slightly different orientation from the other three. There could be some situations where the orientation of flexible barrier sheet 112 is more desirable. Flexible barrier sheet 112 is shown with tailgate mounting tabs 122 extending through the flexible sheet mounting tab receiving orifices 1221 therein. Sheet gripping orifice 101 is shown without any tailgate mounting tabs 122 therein as sheet gripping orifice 101 could be used as a handle by the maintenance workers to bend the flexible barrier sheet 112 and others sheets 110, 114, and 116. Flexible barrier sheet 112 and flexible barrier sheet 110 are shown held in place by clamp bar 123, with flexible sheet mounting bolts 124, which extend through flexible sheet mounting bolt receiving orifices 1241 (FIG. 4).

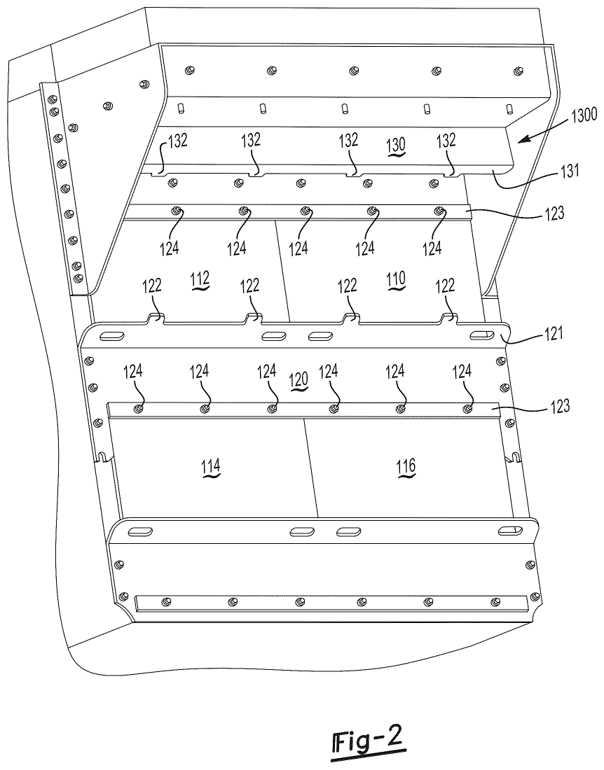

Now referring to FIG. 2, there is shown another representation of the details of the system of FIG. 1. Which includes an upper transverse portion 1300 having an upper main portion 130, an upper protruding portion 131 with a plurality of upper mounting tabs 132 thereon.

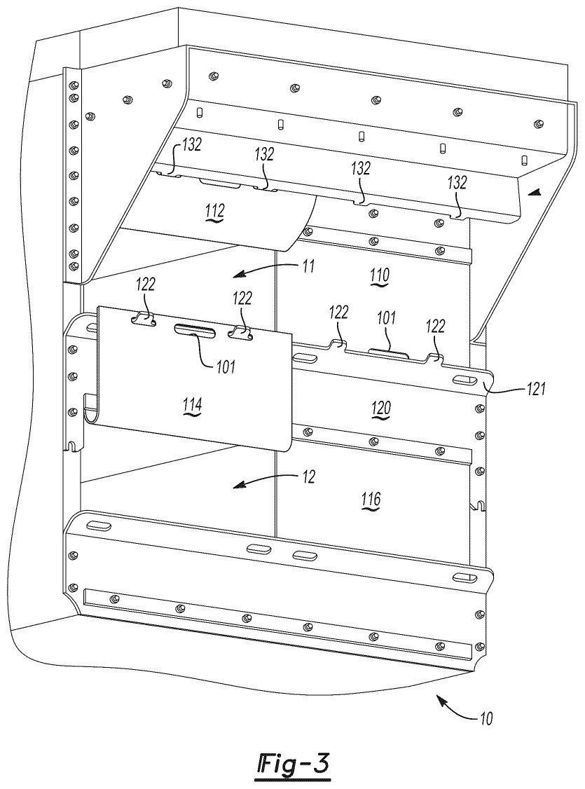

Now referring to FIG. 3, there is shown a view of the system of FIG. 1 where the flexible barrier sheet 112 and flexible barrier sheet 114 have been fully flipped up and attached to upper mounting tabs 132 and tailgate mounting tabs 122 respectively. Note that the screen cloth of the vibrating screen is not shown but would be present in an operating vibrating screening machine. Note that with respect to flexible barrier sheet 112 and 114, the majority of the sheets portion shown in FIG. 3 is an opposite side from that which was shown in FIG. 1. Flexible barrier sheets 110 and 116 show the same side in FIG. 3 as in FIG. 1. The flexible sheet mounting tab receiving orifices 1221 (FIG. 4) in flexible barrier sheets 112 and 114 are shown in FIG. 3 as having upper mounting tabs 132 and tailgate mounting tabs 122 extending therethrough, respectively. The upper mounting tabs 132 and tailgate mounting tabs 122 are not shown disposed in the flexible sheet mounting tab receiving orifices 1221 associated with flexible barrier sheets 110 and 116, respectively.

Now referring to FIG. 4, there is shown more details of the flexible barrier sheet 110 which may be identical to the flexible barrier sheet 112, 114, and 116.

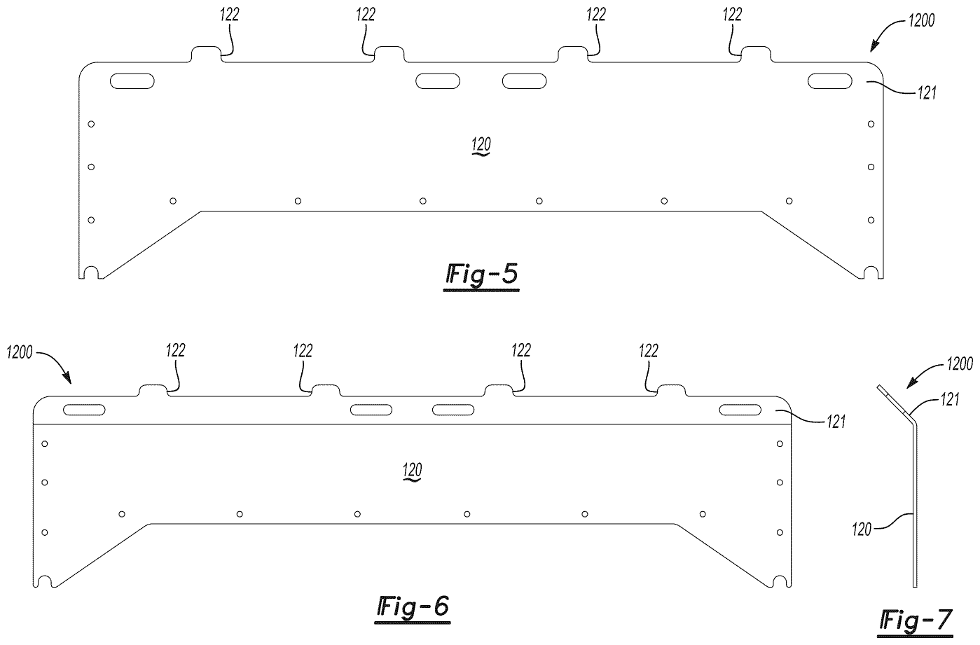

Now referring to FIG. 5, there is shown tailgate portion 1200 in a preformed flat configuration with tailgate flat portion 120 and tailgate protruding portion 121 being co-planar.

Now referring to FIG. 6, there is shown a side view of the tailgate portion 1200 after being formed with a non-planar orientation between tailgate flat portion 120 and tailgate protruding portion 121.

Now referring to FIG. 7, there is shown an end view of the tailgate portion 1200 of FIG. 6.

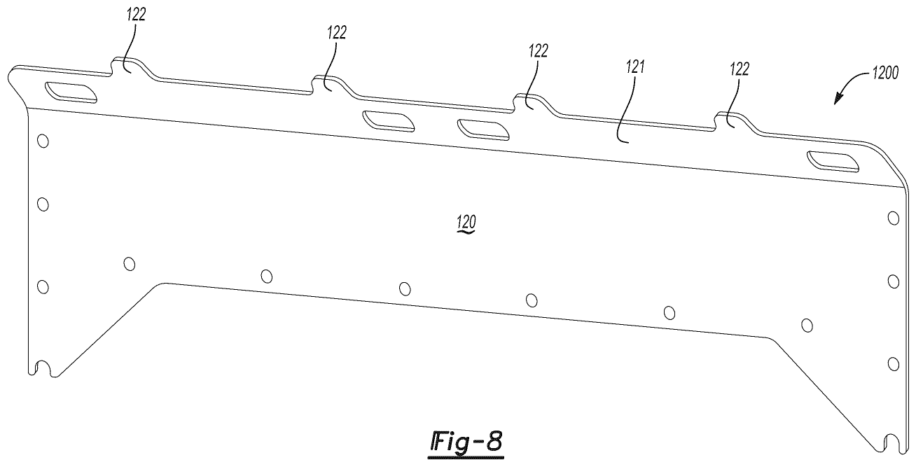

Now referring to FIG. 8, there is shown a perspective view of the tailgate portion 1200 of FIGS. 6 and 7.

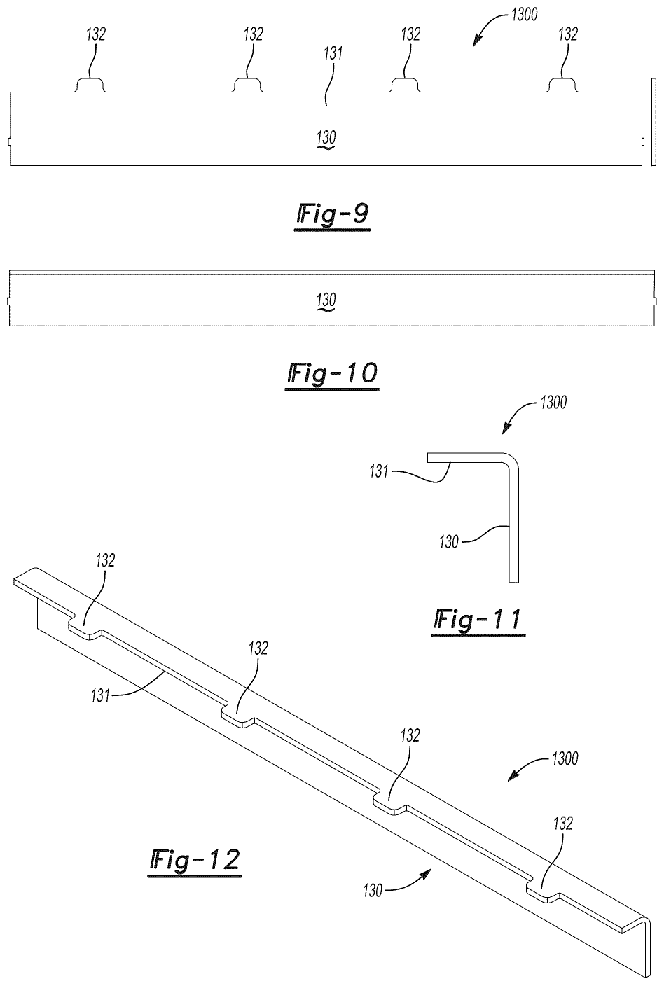

Now referring to FIGS. 9-12, the upper transverse portion 1300 is shown in a preformed flat pattern in FIG. 9 and in post formed (bent) configuration in FIGS. 10, 11, and 12. In FIGS. 10-12, upper main portion 130 and upper protruding portion 131 are post formed and are not co-planar. Consequently, upper mounting tabs 132 are not co-planar with upper main portion 130. But in all FIGS. 9-12, upper mounting tabs 132 are coplanar with upper protruding portion 131.

The precise implementation of the present invention will vary depending upon the particular application.

It is thought that the method and apparatus of the present invention will be understood from the foregoing description and that it will be apparent that various changes may be made in the form, construct steps and arrangement of the parts and steps thereof without departing from the spirit and scope of the invention or sacrificing all of their material advantages. The form herein described is merely a preferred exemplary embodiment thereof.

We claim:

1. A vibrating screen system comprising:
a vibrating screen having at least one screen deck;
at least one flexible barrier sheet having a top portion and a bottom portion;
said top portion being secured to said vibrating screen above said screen deck;
said bottom portion having at least one mounting receiving orifice;
at least one mounting tab disposed on said vibrating screen above said top portion; and
wherein said at least one mounting tab is configured to pass through said at least one mounting receiving orifice to hold said bottom portion in an elevated position creating a maintenance access opening.

2. The vibrating screen system of claim 1, wherein said vibrating screen comprises a multi-deck vibrating screen having a first screen deck and a second screen deck positioned below said first screen deck, and wherein said at least one flexible barrier sheet comprises a first flexible barrier sheet mounted above said first screen deck and a second flexible barrier sheet mounted above said second screen deck.

3. The vibrating screen system of claim 1, further comprising a clamp bar securing said top portion of said at least one flexible barrier sheet to said vibrating screen, wherein said at least one mounting tab comprises a plurality of mounting tabs disposed above said clamp bar.

4. The vibrating screen system of claim 1, wherein said at least one mounting receiving orifice comprises a plurality of mounting tab receiving orifices positioned proximate to said bottom portion of said at least one flexible barrier sheet.

5. The vibrating screen system of claim 1, wherein said flexible barrier sheet includes at least one sheet gripping orifice configured to be used as a handle for bending said at least one flexible barrier sheet upwardly.

6. A method of maintaining a vibrating screen, comprising:
providing a vibrating screen having at least one flexible barrier sheet secured at an upper portion to said vibrating screen above a screen deck;
bending said flexible barrier sheet upwardly from a hanging position to an elevated position;
securing said flexible barrier sheet in said elevated position by engaging at least one retention element on said vibrating screen with at least one receiving opening in a lower portion of said flexible barrier sheet; and
wherein said securing step creates a maintenance access opening allowing worker access to said screen deck.

7. The method of claim 6, wherein said at least one retention element comprises a plurality of mounting tabs disposed above a clamp bar securing said upper portion of said flexible barrier sheet to said vibrating screen.

8. The method of claim 6, wherein said at least one receiving opening comprises a plurality of mounting tab receiving orifices positioned proximate to said lower portion of said flexible barrier sheet.

9. The method of claim 6, wherein said flexible barrier sheet includes at least one sheet gripping orifice configured to be used as a handle for bending said at least one flexible barrier sheet upwardly.

10. The method of claim 6, wherein said at least one flexible barrier sheet comprises a first flexible barrier sheet mounted above a first screen deck and a second flexible barrier sheet mounted above a second screen deck positioned below said first screen deck.

11. A vibrating screen system comprising:
a vibrating screen;
a flexible barrier sheet having an upper portion and a lower portion;
said upper portion being secured to said vibrating screen at a position above a screen deck;
said lower portion having at least one receiving opening;
at least one retention element disposed on said vibrating screen; and
wherein said at least one retention element is configured to engage with said at least one receiving opening to maintain said lower portion in an elevated position, thereby creating a maintenance access space beneath said flexible barrier sheet.

12. The vibrating screen system of claim 11, wherein said vibrating screen comprises a first screen deck and a second screen deck positioned below said first screen deck, and wherein said flexible barrier sheet is mounted above said first screen deck and the system further comprises a second flexible barrier sheet mounted above said second screen deck with a second plurality of receiving openings configured to engage with a plurality of retention elements to hold said second flexible barrier sheet in an elevated position.

13. The vibrating screen system of claim 11, wherein said at least one retention element comprises a plurality of mounting tabs disposed on an upper portion of said vibrating screen, said mounting tabs being positioned to align with corresponding receiving openings in said lower portion of said flexible barrier sheet when said lower portion is raised to said elevated position.

14. The vibrating screen system of claim 11, wherein said at least one receiving opening comprises a plurality of mounting tab receiving orifices positioned proximate to said lower portion of said flexible barrier sheet, said mounting tab receiving orifices being sized to receive and engage with said at least one retention element to secure said flexible barrier sheet in said elevated position.

15. The vibrating screen system of claim 11, wherein said flexible barrier sheet includes at least one sheet gripping orifice configured to be used as a handle for manually bending said flexible barrier sheet upwardly from a hanging position to said elevated position during maintenance operations.

16. A vibrating screen apparatus comprising:
a screen deck for processing material;
a barrier assembly adjacent said screen deck, said barrier assembly comprising:
a flexible sheet member having a first edge secured to the vibrating screen apparatus and a second edge opposite said first edge; and
a retention mechanism configured to releasably secure said second edge in an elevated position relative to said screen deck;
wherein said retention mechanism comprises complementary engagement features on said flexible sheet member and said vibrating screen apparatus that engage when said flexible sheet member is in said elevated position.

17. The vibrating screen apparatus of claim 16, wherein said vibrating screen apparatus comprises a multi-deck vibrating screen having a first screen deck and a second screen deck positioned below said first screen deck, and wherein said barrier assembly includes a first flexible sheet member mounted above said first screen deck and a second flexible sheet member mounted above said second screen deck, each having respective complementary engagement features configured to engage with retention mechanisms of said vibrating screen apparatus.

18. The vibrating screen apparatus of claim 16, wherein said first edge of said flexible sheet member is secured to said vibrating screen apparatus by a clamp bar, and wherein said retention mechanism comprises a plurality of mounting tabs disposed on said apparatus above said clamp bar, said mounting tabs being configured to engage with said complementary engagement features on said flexible sheet member.

19. The vibrating screen apparatus of claim 16, wherein said complementary engagement features comprise a plurality of mounting tab receiving orifices positioned proximate to said second edge of said flexible sheet member, and wherein said retention mechanism comprises a plurality of mounting tabs disposed on said vibrating screen apparatus, said mounting tabs being sized to pass through said mounting tab receiving orifices to maintain said flexible sheet member in said elevated position.

20. The vibrating screen apparatus of claim 16, wherein said flexible sheet member includes at least one sheet gripping orifice configured to be used as a handle for manually bending said flexible sheet member upwardly from a hanging position to said elevated position to create a maintenance access opening.
